(19) United States
(12) Patent Application Publication
(10) Pub. No.: US 2022/0100258 A1
(43) Pub. Date: Mar. 31, 2022

(54) METHOD FOR QUICKLY RESTORING WORKING STATE AND ELECTRONIC DEVICE

(71) Applicant: RAYMX Microelectronics Corp., Hefei (CN)

(72) Inventors: SHUAI LIN, Hefei (CN); QIANGQIANG ZHENG, Hefei (CN)

(21) Appl. No.: 17/149,800

(22) Filed: Jan. 15, 2021

(30) Foreign Application Priority Data
Sep. 30, 2020 (CN) 202011060749.7

(51) Int. Cl. G06F 1/3287; G06F 1/3237

(52) U.S. Cl. CPC G06F 1/3287; G06F 1/3237

(57) ABSTRACT

An electronic device includes a retention circuit, a power-gated circuit, and a control circuit. The power-gated circuit includes a main circuit and a memory. When receiving a sleep signal, the control circuit is configured to cause retention data related to the power-gated circuit to be stored in the retention circuit, and then cause the power-gated circuit to be turned off. When receiving a wakeup signal, the control circuit is configured to cause the power-gated circuit to be turned on, and then cause the retention data stored in the retention circuit to be stored back to the memory of the power-gated circuit. The main circuit of the power-gated circuit performs, according to the retention data stored in the memory, operation for restoring a working state.

### CROSS-REFERENCE TO RELATED APPLICATION

This non-provisional application claims priority under 35 U.S.C. § 119(a) to Patent Application No. 202011060749.7 filed in China, P.R.C. on Sep. 30, 2020, the entire contents of which are hereby incorporated by reference.

### BACKGROUND

### Technical Field

The present disclosure relates to working state restoration technologies and an electronic device implementing the same.

### Related Art

For portability, a majority of electronic devices are equipped with batteries which maintain operation of the electronic devices. An operation time of an electronic device is prolonged through some power consumption reduction technologies.

Common power consumption reduction technologies include clock gating control and power gating control. The clock gating control is to reduce dynamic power consumption in an electronic device by turning off a clock source. Although this can facilitate quick restoration of a working state, but cannot reduce static power consumption in the electronic device. The power gating control is to effectively reduce the static power consumption in the electronic device by disconnecting a power supply line. However, when the electronic device is turned on to restore the working state, the electronic device using the power gating control requires a longer restoration time, affecting experience of a user.

### SUMMARY

The present disclosure provides an electronic device. In an embodiment, the electronic device includes a retention circuit, a power-gated circuit, and a control circuit. The power-gated circuit includes a main circuit and a memory. The control signal is configured to: cause, when receiving a sleep signal, retention data related to the power-gated circuit to be stored in the retention data and then the power-gated circuit to be turned off; and cause, when receiving a wakeup signal, the power-gated circuit to be turned on and then the retention data stored in the retention circuit to be stored back to the memory of the power-gated circuit. The main circuit of the power-gated circuit performs, according to the retention data stored in the memory, operation for restoring a working state.

The present disclosure provides a method for restoring a working state of an electronic device. In an embodiment, the electronic device includes a retention circuit and a power-gated circuit. The power-gated circuit includes a main circuit and a memory. The method includes: causing, when receiving a sleep signal, retention data related to the power-gated circuit to be stored in the retention circuit and then the power-gated circuit to be turned off; and causing, when receiving a wakeup signal, the power-gated circuit to be turned on and then the retention data stored in the retention circuit to be stored back to the memory; wherein the main circuit performs, according to the retention data stored in the memory, operation for restoring the working state.

Detailed features and advantages of the present disclosure are described in detail in the following implementations, and the content of the implementations is sufficient for a person skilled in the art to understand and implement the technical content of the present disclosure. A person skilled in the art can easily understand the objectives and advantages related to the present disclosure according to the contents disclosed in this specification, the claims and the drawings.

### BRIEF DESCRIPTION OF THE DRAWINGS

FIG. 1 is a schematic block diagram of an embodiment of an electronic device;

FIG. 2 is a flowchart of an embodiment of a method for restoring a working state of an electronic device;

FIG. 3 is a schematic block diagram of another embodiment of the electronic device;

FIG. 4 is a flowchart of another embodiment of the method for restoring a working state of an electronic device;

FIG. 5 is a schematic block diagram of still another embodiment of the electronic device; and

FIG. 6 is a flowchart of still another embodiment of the method for restoring a working state of an electronic device.

### DETAILED DESCRIPTION

To make the objectives, features, and advantages of the present disclosure more comprehensible, a detailed description is made below with reference to the accompanying drawings.

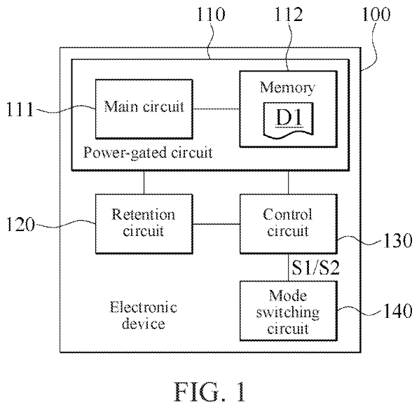

Referring to FIG. 1 to FIG. 6, the electronic device 100 has an operation mode and a sleep mode. In the sleep mode, the electronic device 100 may reduce power consumption through some power consumption reduction technologies to meet requirements of low power consumption. The power consumption reduction technologies may include but are not limited to clock gating control and power gating control. The power gating control is to effectively reduce the power consumption of the electronic device 100 through a turn-off method. However, when to turn on the electronic device 100 from the sleep mode and restore the electronic device to the operation mode to restore normal operation, a relatively long restoration time is required. Based on this, the required restoration time can be greatly reduced for the electronic device 100 by performing the method for restoring a working state of an electronic device according to any embodiment of the present disclosure.

In some implementations, the electronic device 100 may be a solid state drive controller (SSD controller), but the present disclosure is not limited thereto. The electronic device 100 may be any electronic product for which the power gating control is used to reduce power consumption. Of course, the electronic device 100 may be any electronic product for which both the power gating control and the clock gating control are used to reduce power consumption.

Referring to FIG. 1, the electronic device 100 includes a power-gated circuit 110, a retention circuit 120 and a control circuit 130. The control circuit 130 is coupled to the power-gated circuit 110 and the retention circuit 120. The power-gated circuit 110 is coupled to the retention circuit 120. In an embodiment, the electronic device 100 further includes a clock gating control circuit for controlling (e.g. turning off) at least one clock source to reduce a dynamic power consumption of the electronic device 100.

The power-gated circuit 110 may work normally in the operation mode, and may be turned off under the power gating control in the sleep mode, thereby reducing power consumption. The power-gated circuit 110 includes a main circuit 111 and a memory 112. The main circuit 111 is coupled to the memory 112. The main circuit 111 may operate according to retention data D1 in the operation mode. The memory 112 is configured to store retention data D1. The retention data D1 may include configuration and/or state information required for operation of the main circuit 111.

In some implementations, the power-gated circuit 110 may be a power management unit (pmu) in an embedded processor core (EP core), a management data input/output (MDIO), at least one register file (rf) (e.g. a peripheral component interface express (PCIe) register file (PCIe rf)), a host memory buffer register file (HMB rf), or a non-volatile memory register file (NVM rf)), but the present disclosure is not limited thereto. The power-gated circuit 110 may be any circuit that needs to keep an operation value (for example, operation configuration and/or state information) at previous turn-off when to be turned on after the turn-off. In addition, the main circuit 111 of each power-gated circuit 110 may be a circuit other than the memory (or buffer) in any of the foregoing examples, such as a circuit other than a memory (or buffer) in the EP core, a circuit other than a memory (or buffer) in the MDIO, etc.

The retention circuit 120 may be configured to retain data in the sleep mode. The control circuit 130 may be configured to perform a method for restoring a working state of an electronic device 100 according to any embodiment of the present disclosure, so as to effectively reduce power consumption of the electronic device 100 in the sleep mode, and greatly reduce a restoration time for restoring the electronic device 100 from the sleep mode to the operation mode for normal working.

In some implementations, the retention circuit 120 may be implemented by using a master-slave flip flop, a memory having a data retention function, or any other electronic element applicable to data retention. In addition, the control circuit 130 may be implemented by using a system-on-chip (SoC), a central processing unit (CPU), a microcontroller (MCU), an embedded controller, an application specific integrated circuit (ASIC), an application processor (AP), or any other applicable electronic element.

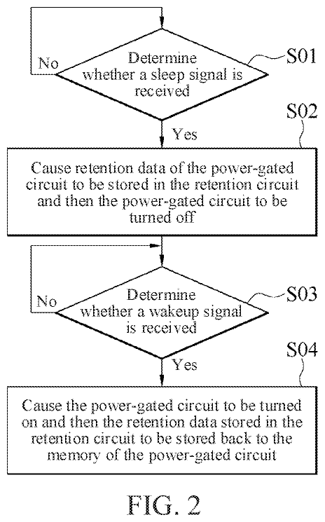

Referring to FIG. 1 and FIG. 2, in a method for restoring a working state of an electronic device according to an embodiment of the present disclosure, when the electronic device 100 operates in the operation mode, the control circuit 130 of the electronic device 100 may determine whether a sleep signal S1 is received (step S01).

In some implementations, the electronic device 100 may further include a mode switching circuit 140, and the sleep signal S1 may be generated by the mode switching circuit 140 when a sleep condition is met. For example, when receiving a sleep instruction, detecting that a current battery level of the electronic device 100 is insufficient, or detecting that a cover of the electronic device 100 is closed on a body, the mode switching circuit 140 generates the sleep signal S1. Alternatively, the mode switching circuit 140 is a physical button and generates the sleep signal S1 when pressed by a user, but the present disclosure is not limited thereto.

When a determining result is that the control circuit 130 receives the sleep signal S1, the control circuit 130 causes, after the retention data D1 of the power-gated circuit 110 is stored in the retention circuit 120, the power-gated circuit 110 to be turned off (step S02) to enter the sleep mode. On the contrary, when the determining result is that the control circuit 130 does not receive the sleep signal S1, the control circuit 130 may return to step S01 after a predetermined time interval to determine again.

In an implementation of step S02, the control circuit 130 may first cause, when receiving the sleep signal S1, the main circuit 111 of the power-gated circuit 110 to store the retention data D1 currently stored in the memory 112 in the retention circuit 120, and cause, after the power-gated circuit 110 completes storage of the retention data D1, the power-gated circuit 110 to be turned off, for example, by switching off an electrical connection between the power-gated circuit 110 and a power supply through the power gating control. A detailed implementation of the power gating control technology is well known in the art, and therefore is not repeated again. In another implementation of step S02, the control circuit 130 may obtain, when receiving the sleep signal S1, the retention data D1 from the memory 112 of the power-gated circuit 110, and store the obtained retention data D1 in the retention circuit 120. Then, the control circuit 130 disables (e.g. turns off) the power-gated circuit 110.

In the method for restoring a working state of an electronic device according to an embodiment of the present disclosure, when the electronic device 100 is in the sleep mode, the control circuit 130 may determine whether a wakeup signal S2 is received (step S03). In some implementations, the wakeup signal S2 may be generated by the mode switching circuit 140 when a wakeup condition is met. For example, when receiving a wakeup instruction and detecting that the cover of the electronic device 100 leaves the body, the mode switching circuit 140 generates the wakeup signal S2, or the mode switching circuit 140 is a physical button and generates the wakeup signal S2 when pressed by a user, but the present disclosure is not limited thereto.

When the determining result is that the control circuit 130 receives the wakeup signal S2, the control circuit 130 may cause, after the power-gated circuit 110 is turned on, the retention data D1 stored in the retention circuit 120 to be stored back to the memory 112 of the power-gated circuit 110 (step S04), so that the main circuit 111 of the power-gated circuit 110 may directly perform, according to the retention data D1 in the memory 112 after entering the operation mode, operation for restoring the working state, thereby quickly returning to a working state before the sleep mode.

In an implementation of step S04, the control circuit 130 may first cause, when receiving the wakeup signal S2, the power-gated circuit 110 to be turned on. For example, the control circuit restores the electrical connection between the power-gated circuit 110 and the power supply through the power gating control, and then causes the main circuit 111 of the power-gated circuit 110 to get back the retention data D1 previously stored in the retention circuit 120 and store the retention data back to the memory 112. In another implementation of step S04, after causing the power-gated circuit 110 to be enabled (e.g. turned on), the control circuit 130 may obtain the retention data D1 from the retention circuit 120, and store the obtained retention data D1 back to the memory 112 of the power-gated circuit 110.

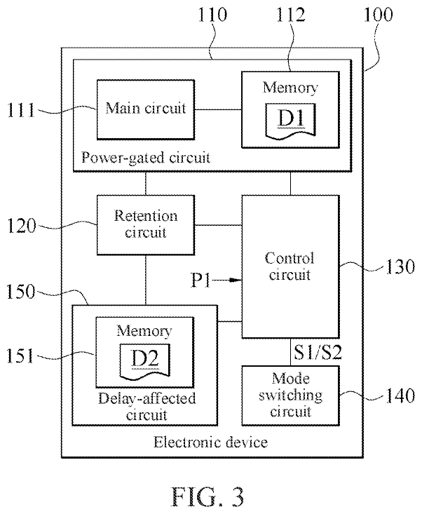

Referring to FIG. 3, in some embodiments, the electronic device 100 may further include a retainable circuit 150. The retainable circuit 150 is coupled to the control circuit 130 and the retention circuit 120. The retainable circuit 150 may work normally in the operation mode, and may be turned off under the power gating control in the sleep mode, thereby reducing power consumption. The retainable circuit 150 includes a memory 151. The memory 151 stores retainable data D2. The retainable data D2 is essentially data that may be initialized. However, initialization of the retainable data requires a long time, affecting a restoration time for restoring the electronic device 100 to a normal working state.

In some implementations, the retainable circuit 150 may be a host memory buffer memory (HMB memory), L2IMEM or L2DMEM in a central processing unit, or an XOR memory for data recovery in a flash memory controller, a parser table, or a sequencer table, but the present disclosure is not limited thereto. The retainable circuit 150 may be any circuit that requires a relatively long initialization time during initialization for turn-on again.

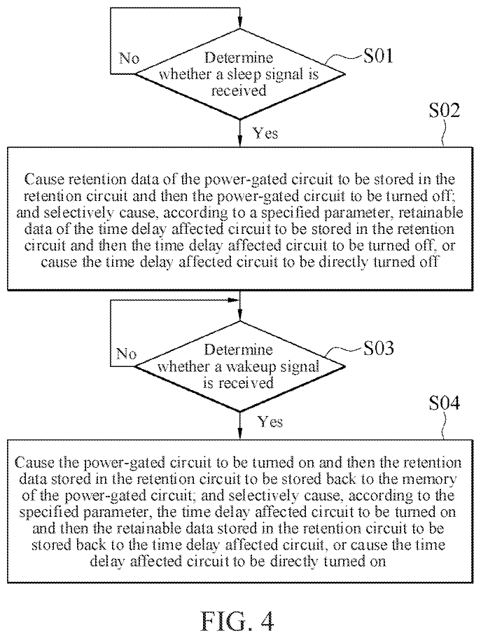

Referring to FIG. 3 and FIG. 4, in another embodiment of step S02, when a determining result is that the control circuit 130 receives the sleep signal S1, the control circuit 130 may further selectively store the retainable data D2 of the retainable circuit 150 in the retention circuit 120 according to a specified parameter P1, and then cause the retainable circuit 150 to be turned off, or selectively cause the retainable circuit 150 to be directly turned off according to the specified parameter P1 to enter the sleep mode. In some implementations, the specified parameter P1 may be stored in the memory 151 or other memories of the electronic device 100. In addition, the specified parameter P1 may be preset by a user according to whether a requirement of the user is a power consumption preference or a restoration time preference. For example, when the specified parameter P1 read by the control circuit 130 is a first value, the control circuit 130 may cause, according to the specified parameter P1, the retainable data D2 of the retainable circuit 150 to be stored in the retention circuit 120 and then the retainable circuit 150 to be turned off to enter the sleep mode. When the specified parameter P1 read by the control circuit 130 is a second value, the control circuit 130 may cause, according to the specified parameter P1, the retainable circuit 150 to be directly turned off to enter the sleep mode.

In some implementations, when the control circuit 130 selectively causes, according to the specified parameter P1, the retainable data D2 of the retainable circuit 150 to be stored in the retention circuit 120, the control circuit 130 may cause the retainable circuit 150 to actively store the retainable data D2 in the retention circuit 120, and causes, after the retainable circuit 150 completes storage of the retainable data D2, the retainable circuit 150 to be turned off, for example, cuts off an electrical connection between the retainable circuit 150 and a power supply through the power gating control. However, the present disclosure is not limited thereto. In some other implementations, the control circuit 130 may further directly obtain the retainable data D2 from the retainable circuit 150, and store the obtained retainable data D2 in the retention circuit 120, and then turn off the retainable circuit 150.

Correspondingly, in another embodiment of step S04, when the determining result is that the control circuit 130 receives the wakeup signal S2, the control circuit 130 may further selectively cause, according to the specified parameter P1, the retainable circuit 150 to be turned on and then the retainable data D2 stored in the retention circuit 120 to be stored back to the retainable circuit 150, or selectively cause, according to the specified parameter P1, the retainable circuit 150 to be directly turned on. For example, when the specified parameter P1 read by the control circuit 130 is the first value, the control circuit 130 may cause, according to the specified parameter P1, the retainable circuit 150 to be turned on and then the retainable data D2 stored in the retention circuit 120 to be stored back to the retainable circuit 150. When the specified parameter P1 read by the control circuit 130 is the second value, the control circuit 130 may cause, according to the specified parameter P1, the retainable circuit 150 to be directly turned on.

In some implementations, when the control circuit 130 selectively causes, according to the specified parameter P1, the retainable data D2 stored in the retention circuit 120 to be stored back to the retainable circuit 150, the control circuit 130 may cause the retainable circuit 150 to actively get back the retainable data D2 previously stored in the retention circuit 120 and store the retainable data back to the memory 151. However, the present disclosure is not limited thereto. In some other implementations, the control circuit 130 may further directly obtain the retainable data D2 from the retention circuit 120 and store the obtained retainable data D2 back in the memory 151.

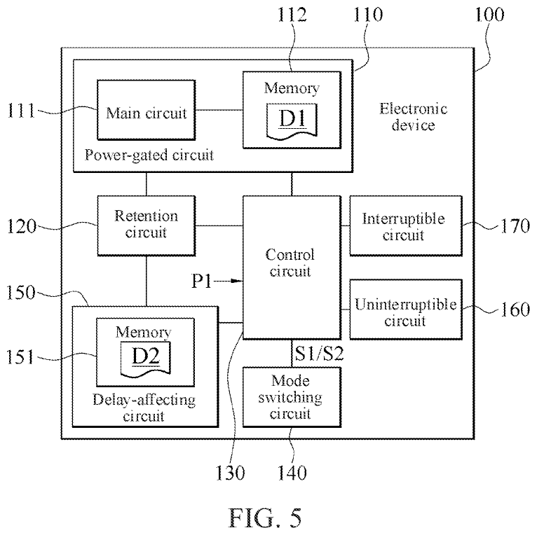

Referring to FIG. 5, in some embodiments, the electronic device 100 may further include an uninterruptible circuit 160. In some embodiments, the electronic device 100 further includes an uninterruptible circuit 160 and an interruptible circuit 170. The interruptible circuit 170 is coupled to the control circuit 130. The uninterruptible circuit 160 may work normally in the operation mode, and is not turned off under the power gating control in the sleep mode. The interruptible circuit 170 may work normally in the operation mode, and is turned off under the power gating control in the sleep mode, thereby reducing power consumption. In some embodiments, when the control circuit 130 receives the sleep signal, the control circuit 130 is further configured to cause the interruptible circuit 170 to be directly turned off. When the control circuit 130 receives the wakeup signal, the control circuit 130 is configured to cause the interruptible circuit 170 to be directly turned on later. For example, the interruptible circuit 170 is directly turned on after the control circuit 130 receives the wakeup signal. For another example, the interruptible circuit 170 is directly turned on a predetermined period of time after the control circuit 130 receives the wakeup signal. The predetermined period of time may be set by a designer. In some embodiments, when the control circuit 130 receives the wakeup signal, the control circuit 130 is further configured to cause the interruptible circuit 170 to be directly turned on after the power-gated circuit 110 is turned on. In some embodiments, when control circuit 130 receives the sleep signal, the control circuit 130 is further configured to cause the interruptible circuit 170 to be directly turned off before the power-gated circuit 110 is turned off.

In some embodiments, the uninterruptible circuit 160 is coupled to the control circuit 130. Although the uninterruptible circuit 160 in the sleep mode is not turned off under the power gating control, an electrical connection between the uninterruptible circuit and a clock signal source is cut off under the power gating control, thereby reducing power consumption of the uninterruptible circuit. A detailed implementation of the clock gating control technology is well known in the art, and therefore is not repeated again.

In some embodiments, the uninterruptible circuit 160 may be an uninterruptible power system (UPS), a power control unit (pcu), an uninterruptible memory (AON MEM), a system register file (Sys rf), a dynamic voltage frequency scaling (DVFS) circuit, a connection pad (PAD) of a system controller, or a power supply (VCCKS) of the flash memory controller. However, the present disclosure is not limited thereto. The uninterruptible circuit 160 may be any circuit that is not suitable to be turned off, such as a circuit that controls an entire system of the electronic device 100 or a power supply policy of each module in the electronic device 100. In addition, the interruptible circuit 170 may be an input/output related circuit (which may include, for example, but is not limited to, I2C, GPIO, UART, various interface circuits, etc.), a clock generator (CKgen), an analog physical layer (APHY), a digital physical layer (DPHY), a temperature sensor (TM), an internal read-only memory (IROM), or a slow connection pad (ONFIPAD) of a flash memory controller. However, the present disclosure is not limited thereto. The interruptible circuit 170 may be any circuit that may be restored to an initial state after the circuit is turned on again.

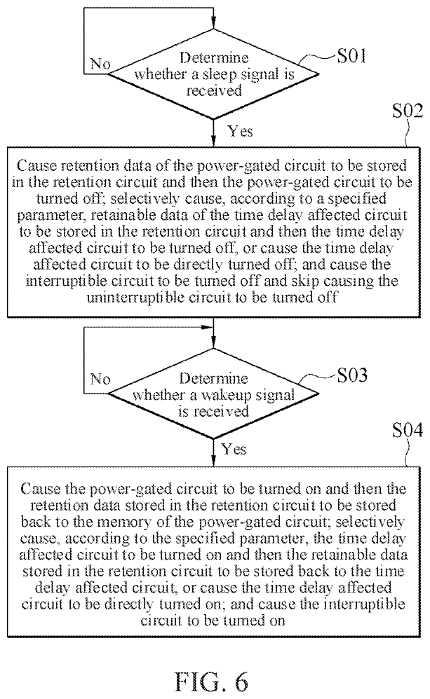

Referring to FIG. 5 and FIG. 6, in another embodiment of step S02, when the determining result is that the control circuit 130 receives the sleep signal S1, the control circuit 130 may further cause the interruptible circuit 170 to be turned off and skip causing the uninterruptible circuit 160 to be turned off (in other words, the control circuit 130 keeps the uninterruptible circuit to be turned on). For example, the control circuit 130 may cut off an electrical connection between the interruptible circuit 170 and the power supply through the power gating control, and maintain an electrical connection between the uninterruptible circuit 160 and the power supply.

Correspondingly, in another embodiment of step S04, when the determining result is that the control circuit 130 receives the wakeup signal S2, the control circuit 130 may further cause the interruptible circuit 170 to be turned on, for example, restore the electrical connection between the interruptible circuit 170 and the power supply through the power gating control.

Based on the foregoing, according to the electronic device and the method for restoring a working state of an electronic device according to the embodiments of the present disclosure, the retention data of the power-gated circuit is first stored in the retention circuit before the power-gated circuit is turned off, and the retention data stored in the retention circuit is stored back to the power-gated circuit after the power-gated circuit is turned on, so that the power consumption of the electronic device in the sleep mode can be effectively reduced, and the restoration time for turning on the electronic in the sleep mode to restore normal working can be greatly reduced, thereby optimizing experience of a user when using the electronic device.

Although the present disclosure has been described in considerable detail with reference to certain preferred embodiments thereof, the disclosure is not for limiting the scope of the disclosure. Persons having ordinary skill in the art may make various modifications and changes without departing from the scope and spirit of the disclosure. Therefore, the scope of the appended claims should not be limited to the description of the preferred embodiments described above.

1. An electronic device, comprising:
a retention circuit;
a power-gated circuit comprising a main circuit and a memory;
a control circuit configured to:
cause, when receiving a sleep signal, retention data corresponding to the power-gated circuit to be stored in the retention circuit and then cause the power-gated circuit to be turned off; and
cause, when receiving a wakeup signal, the power-gated circuit to be turned on and then cause the retention data stored in the retention circuit to be stored back to the memory of the power-gated circuit, wherein the main circuit of the power-gated circuit performs operation according to the retention data stored in the memory; and
an interruptible circuit, wherein the control circuit is further configured to cause, when receiving the sleep signal, the interruptible circuit to be directly turned off before the power-gated circuit is turned off.

2. The electronic device according to claim 1, further comprising:
a retainable circuit, wherein
the control circuit is further configured to selectively
cause, according to a specified parameter when receiving the sleep signal, retainable data corresponding to the retainable circuit to be stored in the retention circuit and then cause the retainable circuit to be turned off; or
cause the retainable circuit to be directly turned off; wherein the retainable data is data required for the retainable circuit during initialization; and
the control circuit is further configured to selectively
cause, according to the specified parameter when receiving the wakeup signal, the retainable circuit to be turned on and then cause the retainable data stored in the retention circuit to be stored back to the retainable circuit; or
cause the retainable circuit to be directly turned on.

3. The electronic device according to claim 2, further comprising:
an uninterruptible circuit, wherein the control circuit is further configured to keep, when receiving the sleep signal, the uninterruptible circuit to be turned on.

4. The electronic device according to claim 3, wherein the power-gated circuit is a power management unit in a processor core, a management data input/output, a host memory buffer register file, a peripheral component interface express register file, or a non-volatile memory register file.

5. The electronic device according to claim 3, wherein the uninterruptible circuit is an uninterruptible power system, a power control unit, an uninterruptible memory, a system register file, a dynamic voltage frequency scaling circuit, or a power supply of a flash memory controller.

6. (canceled)

7. The electronic device according to claim 1, wherein the control circuit is further configured to cause, when receiving the wakeup signal, the interruptible circuit to be directly turned on after the power-gated circuit is turned on.

8. (canceled)

9. The electronic device according to claim 1, wherein the interruptible circuit is an input/output circuit, a clock generator, an analog physical layer, a digital physical layer, or a temperature sensor.

10. The electronic device according to claim 1, wherein the electronic device is a solid state drive controller.

11. A method for restoring a working state of an electronic device, wherein the electronic device comprises a retention circuit, a power-gated circuit, and an interruptible circuit, the power-gated circuit comprises a main circuit and a memory, and the method comprises:
causing, when receiving a sleep signal, retention data related to the power-gated circuit to be stored in the retention circuit and then causing the retention circuit to be turned off;
causing, when receiving a wakeup signal, the power-gated circuit to be turned on and then causing the retention data stored in the retention circuit to be stored back to the memory, wherein the main circuit performs, according to the retention data stored in the memory, operation for restoring the working state; and
when receiving the sleep signal, causing the interruptible circuit to be turned off at the time early than the power-gated circuit is turned off.

12. The method according to claim 11, wherein the electronic device further comprises a retainable circuit, and the method further comprises:
selectively, according to a specified parameter when receiving the sleep signal,
causing retainable data related to the retainable circuit to be stored in the retention circuit and then causing the retainable circuit to be turned off; or
causing the retainable circuit to be directly turned off; and
selectively, according to the specified parameter when receiving the wakeup signal,
causing the retainable circuit to be turned on and then causing the retainable data stored in the retention circuit to be stored back to the retainable circuit; or
causing the retainable circuit to be directly turned on.

13. The method according to claim 12, wherein the electronic device further comprises an uninterruptible circuit, and the method further comprises:
when receiving the sleep signal, keeping the uninterruptible circuit to be turned on.

14. The method according to claim 13, wherein the power-gated circuit is a power management unit in a processor core, a management data input/output, a host memory buffer register file, a peripheral component interface express register file, or a non-volatile memory register file.

15. The method according to claim 13, wherein the uninterruptible circuit is an uninterruptible power system, a power control unit (pcu), an uninterruptible memory (AON MEM), a system register file, a dynamic voltage frequency scaling circuit, or a power supply of a flash memory controller.

16. (canceled)

17. The method according to claim 11, further comprising
when receiving the wakeup signal, causing the interruptible circuit to be directly turned on after the power-gated circuit is turned on.

18. (canceled)

19. The method according to claim 11, wherein the interruptible circuit is an input/output related circuit, a clock generator, an analog physical layer, a digital physical layer, or a temperature sensor.

20. The method according to claim 11, wherein the electronic device is a solid state drive controller.

21. An electronic device, comprising:
a retention circuit;
a power-gated circuit comprising a main circuit and a memory;
a control circuit configured to:
cause, when receiving a sleep signal, retention data corresponding to the power-gated circuit to be stored in the retention circuit and then cause the power-gated circuit to be turned off; and
cause, when receiving a wakeup signal, the power-gated circuit to be turned on and then cause the retention data stored in the retention circuit to be stored back to the memory of the power-gated circuit, wherein the main circuit of the power-gated circuit performs operation according to the retention data stored in the memory; and
an interruptible circuit, wherein the control circuit is further configured to cause, when receiving the wakeup signal, the interruptible circuit to be directly turned on after the power-gated circuit is turned on.
